(19) United States
(12) Patent Application Publication
(10) Pub. No.: US 2021/0207630 A1
(43) Pub. Date: Jul. 8, 2021

(54) Profiled Clamp

(71) Applicant: NORMA Germany GmbH, Maintal (DE)

(72) Inventors: Viktor Stoll, Großkrotzenburg (DE); Detlef Henrich, Limeshain (DE); Stephan Mann, Biebergemünd (DE); Fabio Ghirardi, Hanau (DE)

(21) Appl. No.: 17/055,746

(22) PCT Filed: Apr. 30, 2019
(86) PCT No.: PCT/EP2019/061061

§ 371 Date: Nov. 16, 2020

(30) Foreign Application Priority Data
May 15, 2018 (DE) 10 2018 111 539.3

(51) Int. Cl. F16B 2/08; F16L 33/035

(52) U.S. Cl. CPC F16B 2/08; F16L 23/10; F16L 33/035

(57) ABSTRACT

A profiled clamp having a clamp band which itself has a tensioning head at each end. The tensioning heads are connected to each other via a tensioning device. To allow flexible manufacture, the clamp band has a profiled element and a module frame which extends in a circumferential direction, to which the profiled element is connected, and on which the profiled element is supported at least in a radial direction. The tensioning heads are situated on ends of the module frame.

### INTRODUCTION

The disclosure relates to a profiled clamp having a clamp band which has a tensioning head at each of its ends, the tensioning heads being connected to one another via a tensioning device.

Profiled clamps are reliable connecting elements for use in many fields of industry in which abutting pipes which are provided at their ends with peripheral flanges are intended to be connected to one another in a pressuretight manner. Here, the clamp band has for example a V-shaped profile with two flanks which are connected to one another via a flat base. The profiled clamp is then applied to the flanges of the pipes such that, upon tensioning of the profiled clamp, the profiled clamp then exerts not only radially acting forces but also axially acting forces on the flanges, with the result that the pipes are pressed axially toward one another and a tight connection is obtained.

Conventional profiled clamps generally have a relatively inflexible clamp band which, for mounting on the flanges of the pipes, typically requires at least one articulation point on account of the bending-open of the profiled clamp that is necessary for this purpose. Furthermore, it is often necessary to dimension the profiled clamp exactly with regard to the respective requirements, with the result that, for example for different diameters, different production tools are also required.

### SUMMARY

One object on which the disclosure is thus based, per an embodiment, is to provide a profiled clamp which can be produced with little effort and complexity. In particular, profiled clamps having different diameters are intended to be able to be produced without great effort and complexity.

In a profiled clamp having a clamp band which has a tension head at each of its ends, said tensioning heads being connected to one another via a tensioning device, there is provision according to an embodiment of the disclosure that the clamp band has a profiled element and a module frame which extends in a circumferential direction, to which the profiled element is connected and on which it is supported at least in a radial direction, wherein the tensioning heads are arranged on ends of the module frame.

In this embodiment there occurs a functional separation of the module frame via which the radial tensioning heads are transmitted, of the tensioning heads which are connected to the tensioning device, and of the profiled element which, in addition to radial forces, can also transmit axial forces to the flanges of the pipe connection to be produced. It is thus possible for example to produce the module frame with the profiled element or else separately from the profiled element in any desired length and thus to adapt it to the desired diameter of the profiled clamp in a simple manner. It is also possible for the module frame to be combined with different profiled elements and/or tensioning heads such that the profiled clamp can be variably adapted to the respectively desired requirements. Overall, there is thus obtained a very flexible profiled clamp which can be produced with little effort or complexity and can be adapted to different requirements.

In an embodiment, the profiled element has a plurality of profiled segments which are arranged next to one another in the circumferential direction and which are connected to one another at least by the module frame. The profiled segments then give the profiled clamp a high degree of flexibility for adapting the diameter of the profiled clamp. The latter can thus, on the one hand, be applied to the flanges in a simple manner and, on the other hand, its diameter can be reduced without problem upon tensioning of the tensioning device. The exerted tensioning forces can thus be converted to a high degree into radial or axial forces.

In an embodiment, the profiled segments are connected to one another in an integrally bonded manner, wherein the profiled segments are in particular formed in one piece with one another. The profiled element with the profiled segments can then be produced relatively simply from a strip-shaped material, wherein the relative position of the individual profiled segments is predetermined and the profiled element is cut to length in a simple manner with the corresponding number of profiled segments. It is therefore simple to produce profiled clamps having different diameters.

In an embodiment, there is provision that the profiled segments are individually fastened to the module frame. The profiled element is thus composed of mutually separate individual profiled segments which are each individually fastened to the module frame at a distance from one another, with the result that their position is predetermined by the module frame. Here, a number of profiled segments that is dependent on the diameter of the profiled clamp is selected in a simple manner and then fastened to the module frame. This allows flexible manufacture.

The module frame at least partially covers a radial outer side of the profiled element. As a result, radial forces can be transmitted simply from the module frame to the profiled element, wherein the profiled elements are clamped in between the module frame and the flanges of the pipes. There is thus no need for high demands to be placed on the fastening between the profiled element and the module frame. This fastening must only ensure that the module frame and the profiled element cannot be inadvertently released from one another prior to the mounting operation.

In an embodiment, the module frame is formed from an element of sheet metal form. The module frame thus constitutes a planar element which can be readily produced from a strip-like material. At the same time, the module frame can reliably transmit the introduced tensioning forces.

The profiled element has a corrugated structure with corrugation crests and corrugation troughs which run in an axial direction, wherein a receptacle suitable for receiving flanges of a pipe connection is formed in the corrugation crests, wherein the receptacles of the corrugation crests are arranged in the same axial position. The profiled element can thus be produced for example by folding a strip-like element into which the receptacles are then incorporated if they have not been incorporated beforehand in the form of cutouts. It is thus possible in a relatively simple manner to produce the profiled element in one piece in any desired length. With the profiled clamp mounted, the flanges of the pipes are then situated within the receptacles, which lie on an imaginary circle line.

In an embodiment, the module frame has two strands which run substantially in the circumferential direction and which are arranged parallel to one another and spaced apart from one another in the axial direction, wherein the profiled element connects the two strands in the axial direction. The module frame is thus of two-part configuration, in this embodiment, with the position of the strands with respect to one another being predetermined by the profiled elements. This performs a high degree of variability, especially since a width of the profiled clamp in the axial direction is then independent of the module frame. Rather, the strands of the module frame can be combined with any desired profiled elements or profiled segments and tensioning heads. Here, the provision of two strands which run parallel to one another can achieve a sufficient strength, with the result that high tensioning forces can be introduced symmetrically.

In an embodiment, the strands are formed from a wire rope in each case. Wire ropes comprise a multiplicity of individual filaments and have a high tensile strength combined at the same time with a high degree of flexibility. Furthermore, they can be produced in any desired length in a cost-effective manner.

In an embodiment, there is provision that the strands are formed from a solid wire cable in each case. Unlike wire ropes, a wire cable is not formed from a plurality of elements but constitutes a solid body. This affords a lower degree of flexibility but a higher degree of stiffness, which may be advantageous depending on the requirements. Wire cables can also be produced in the desired length in a cost-effective manner.

The profiled element is curved radially outward between its axial edges. With the profiled clamp ready-mounted, the axial edges of the profiled element are thus situated radially further inward than a base of the profiled element that interconnects the flanks of the profiled element which are guided radially outwardly from the axial edges. The profiled element is thus pulled well and truly around the flanges of the pipes by the strands of the module frame and thus passes these flanges against one another in the axial direction. Furthermore, in this embodiment, the profiled clamp has hardly any bulk in the radial direction and can thus be used even in confined space conditions.

In an embodiment, there is provision that the profiled element has at each of its axial edges a radially outwardly open groove through which one of the strands is respectively guided. The strands are thus held reliably on the profiled element or the profiled segments. Here, an additional fastening can be achieved by a press fit or a frictional engagement within the grooves, with it also being possible for crimping, that is to say a subsequent compression of the grooves, to occur. As a result, the profiled element is then captively connected to the strands or the module frame without additional securing means.

In an embodiment, the profiled element has at each of its axial edges a material doubling which is produced by folding and around which a strand engages in each case. The profiled element or the profiled segments is/are then particularly stable in the contact region with the module frame, and therefore a good introduction of force can occur. Here, the strands of the module frame have in particular an angle profile such that they bear against the profiled element or the profiled segments in a form-fitting manner both in an axial direction and in a radial direction.

The tensioning heads, in this embodiment, each have a tensioning bolt around which the modular frame is at least partially guided in each case. This ensures a reliable transmission of force since large-area contact is obtained by the module frame being guided around the tensioning bolts. Furthermore, it is possible without great effort for the tensioning bolts to be received within the tensioning heads in a form-fitting manner or to directly form the tensioning heads.

In the case of one or more screws as tensioning device, there is provision here that one or more threads for the screw are integrated in one of the tensioning heads, while a leadthrough for the screw is provided in the other screwed bolt. Tensioning of the profiled clamp is thus possible with little effort, with it being the case that relatively high tensioning forces can be introduced.

To tension the profiled clamp, the tensioning device applies a force to the tensioning heads such that they are urged toward one another. The tensioning heads are thus moved toward one another to tension the profiled clamp, with the result that a corresponding reduction in the diameter of the profiled clamp is brought about.

In an embodiment, there is provision that, to tension the profiled clamp, the tensioning device applies a force to the tensioning heads such that they are urged away from one another. To reduce the diameter of the profiled clamp, the tensioning heads are thus pressed apart. For this purpose, the ends of the clamp band cross over one another in the region of the tensioning device.

### BRIEF DESCRIPTION OF THE FIGURES

Further features, details and advantages of the disclosure will become apparent from the wording of the claims and from the following description of embodiments with reference to the drawings, in which, in a schematic view:

FIG. 1 shows a profiled clamp of a first embodiment,

FIG. 2 shows a detail of the profiled clamp from FIG. 1,

FIG. 3 shows a profiled segment of a profiled element,

FIG. 4 shows a strand of a module frame in cross section,

FIG. 5 shows a further strand of a module frame in cross section,

FIG. 6 shows an alternative embodiment of the profiled element with module frame,

FIG. 7 shows a profiled segment of a further embodiment in a side view,

FIG. 8 shows a further embodiment of the profiled element with module frame,

FIG. 9 shows a variant of the profiled element,

FIG. 10 shows a first embodiment of a tensioning head,

FIG. 11 shows a second embodiment of a tensioning head,

FIG. 12 shows a third embodiment of a tensioning head,

FIG. 13 shows a fourth embodiment of a tensioning head,

FIG. 14 shows acting forces in tensioning heads which are tensioned toward one another, and

FIG. 15 shows acting forces in tensioning heads which are tensioned away from one another.

### DETAILED DESCRIPTION

FIG. 1 illustrates a profiled clamp 1 which has a clamp band 2 at each of whose ends there is arranged a tensioning head 4, 5. The tensioning heads 4, 5 are connected to one another via a tensioning device 6 which in this example takes the form of a tensioning screw. Consequently, upon tensioning of the profiled clamp 1, the tensioning heads 4, 5 are pressed toward one another and thus a diameter of the profiled clamp 1 is reduced.

The clamp band 2 comprises a module frame 3 with a profiled element 7 which has a plurality of profiled segments 8 which are connected to one another via the module frame 3. The clamp band 2 is thus of multipart design, with a free gap being formed in each case between the profiled segments 8 of the profiled element 7, with the result that the profiled clamp 1 is relatively flexible.

In this embodiment, the module frame 3 is formed by two strands 9, 10 which run in the circumferential direction and whose ends are guided through the tensioning heads 4,5 and held there in a form-fitting manner.

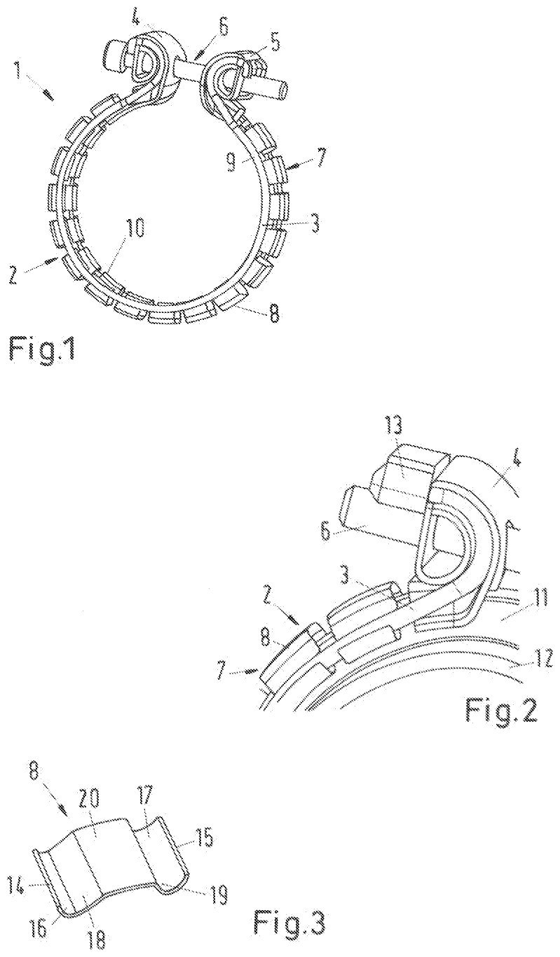

FIG. 2 illustrates an enlarged detail of the profiled clamp 1 from FIG. 1. Here, the profiled clamp 1 is placed on the flange 11 of a pipe connection 12. The ends of the module frame 3 or of the strands which are guided through the tensioning head 4 are here connected to one another by a stop element 13 in such a way that the strands can no longer be pulled out of the tensioning head 4. Rather, the stop element 13, which bears on the outside against the tensioning head 4, produces a form-fitting, tension-resistant connection.

The profiled segments 8 have at each of their axial edges 14, 15 a radially outwardly open groove 16, 17 (FIG. 3). Between them, the profiled segment 8 is radially outwardly deformed and thus forms a profile with two flanks 18, 19 and a base 20 formed therebetween which encloses the flange 11 of the pipe connection 12 in such a way that, upon tensioning of the profiled clamp 1, not only radial forces but also axial forces are exerted on the pipe connection 12.

One of the strands 9, 10 can be respectively received in the grooves 16, 17. Upon tensioning of the profiled clamp 1, the profiled segments 8 of the profiled element 7 are thus pressed radially inwardly, with it being the case that the strands 9,10 are pressed into the grooves 16,17 and are thus reliably held.

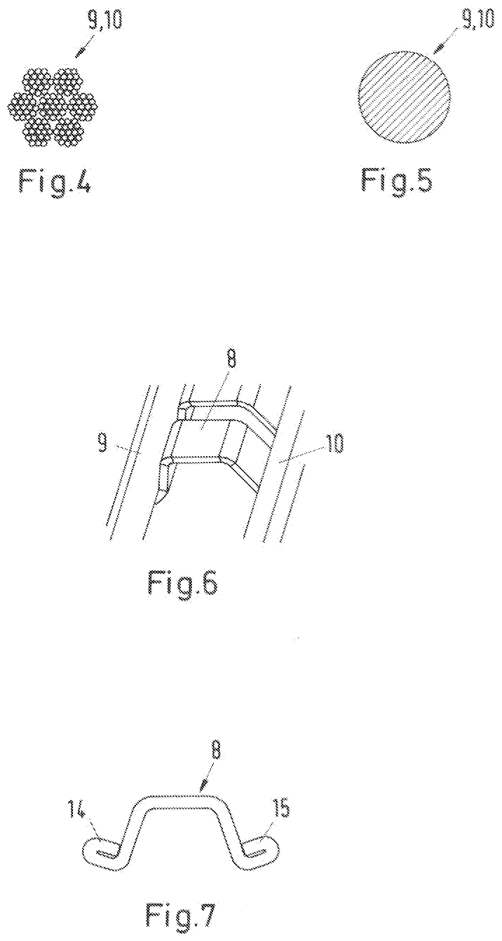

FIG. 4 illustrates a cross section of one of the strands 9, 10 which takes the form of a wire rope with a multiplicity of wire filaments. Such a configuration allows a very flexible module frame.

FIG. 5 shows a cross section of a strand 9, 10 taking the form of a wire cable. Unlike the configuration as shown in FIG. 4, said strand consists of a solid material and is accordingly suited to forming a stiffer module frame.

FIG. 6 shows a further embodiment of the clamp band 2 in which the module frame 3 is likewise formed by two strands 9, 10 which, however, are not received in grooves at the axial edges 14, 15 of the profiled element 7 but engage around the axial edges 14, 15 and thereby bear against a radial outer side and against an axial outer side of the edges 14, 15. The axial edges 14,15 of the individual profiled segments 8 are bent over in such a way that they have a material doubling (FIG. 7). They are consequently capable of taking up relatively high forces.

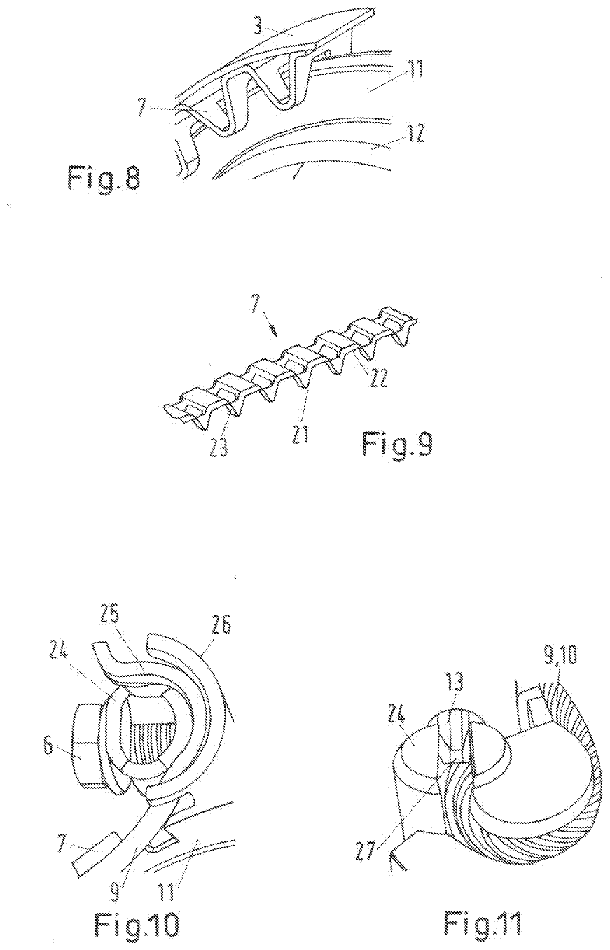

FIG. 8 shows an alternative embodiment of the profiled clamp 1 in which the module frame 3 is formed from an element in the form of sheet metal and lies on a radial outer side of the profiled element 7. Here, the profiled element 7 has a corrugated structure with corrugation crests 21 and corrugation troughs 22 which run in the axial direction. In the corrugation crests 22 there are formed receptacles 23 in which the flange 11 of the pipe connection 12 is received. Here, each corrugation crest 21 forms as it were a profiled segment.

FIG. 9 shows the profiled element 7 in developed form. Depending on the desired diameter of the profiled clamp, said element can be brought to the desired length and is accordingly universally usable.

FIG. 10 illustrates a variant of the tensioning head 4 in which the tensioning head 4 has a tensioning bolt 24 and the end 25 of the strand 9 is guided through between the tensioning bolt 24 and a further element 26 of the tensioning head to 4. Upon tightening of the tensioning device 6 in the form of a screw, the strands 9, 10 are thus clamped in the tensioning head and hence reliably secured.

FIG. 11 shows an embodiment of the tensioning head for strands 9, 10 which take the form of a wire rope and are accordingly flexible. Here, the ends of the strands are guided through the tensioning bolt 24 and then provided with a stop element 13 such that they cannot be pulled out again via a pulling force in the circumferential direction. For this purpose, a leadthrough in the form of a slot 27 is formed in the tensioning bolt 24.

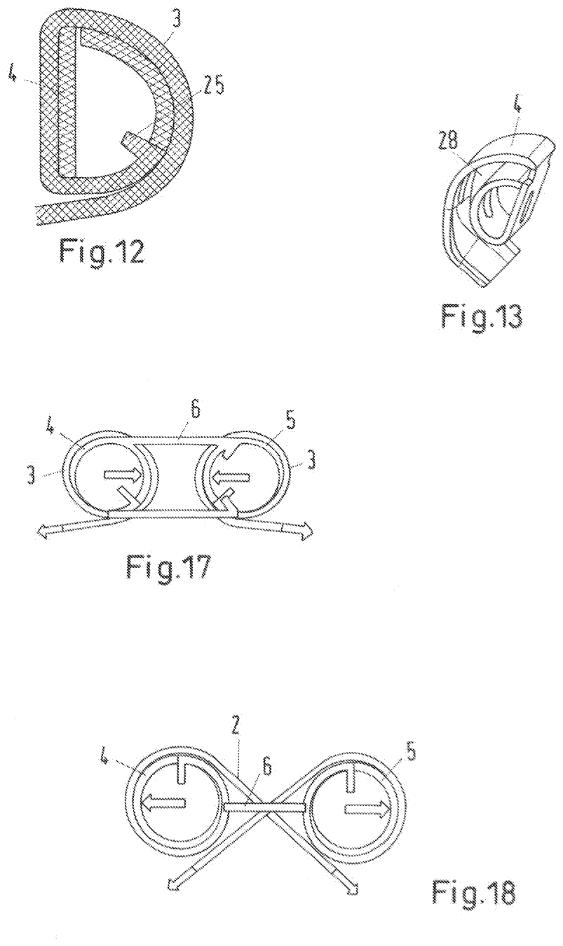

FIG. 12 now shows a variant of the tensioning head in which the module frame 3 is guided around the tensioning head 4 and then engages by way of an end 25 through an opening in the tensioning head 4. Consequently, the module frame 3 is connected to the tensioning head 4 in a form-fitting and frictionally locking manner. A good introduction of force is thus possible.

FIG. 13 shows a further embodiment of the tensioning head in which a guide 28 for the module frame 3 is formed in the tensioning head. The module frame 3, in particular if it has two strands, is then guided through the guide 28 and comes out of the tensioning head again by its end and can be secured there with a stop element. This embodiment allows an advantageous, large-area transmission of the forces and a stiff design of the tensioning head.

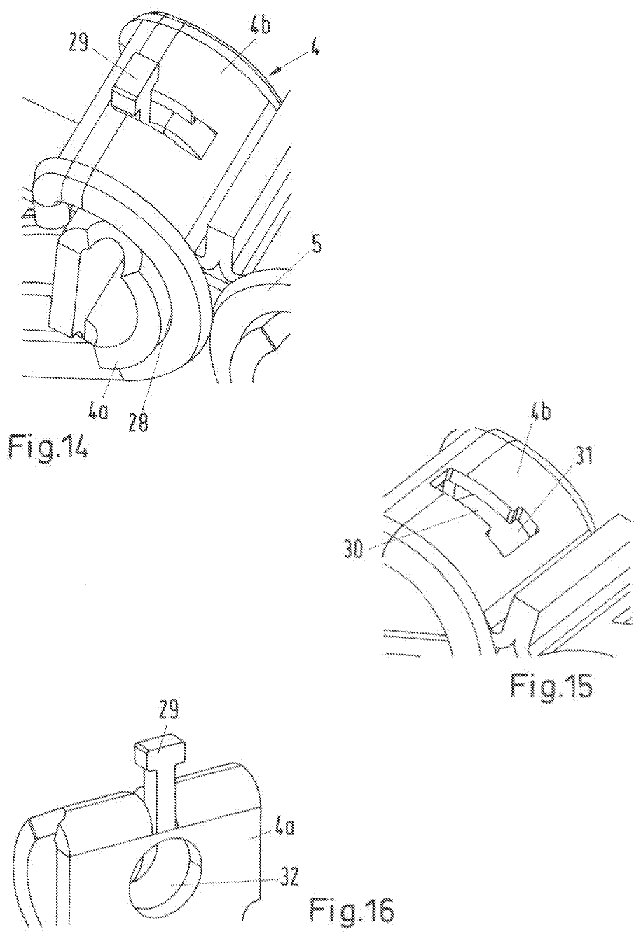

The embodiment of the tensioning head 4 that is shown in FIG. 14 differs from the embodiment as shown in FIG. 13 in that the tensioning head is of two-part design with an inner part 4a and an outer part 4b. Between the inner part 4a and the outer part 4b there is formed the guide 28 for the module frame 3, which can then be received clamped between the inner part 4a and the outer part 4b. In relation to the embodiment according to FIG. 13, a simpler production results.

The inner part 4a and the outer part 4b are connected to one another via a T-shaped hook 29 which is formed in one piece with the inner part 4 and engages in a slot 30 in the outer part 4b. For example, during the production of the inner part 4a, the T-shaped hook is stamped out of the material, which is initially present flat, and, after forming the material to give the more or less cylindrical inner part 4a, then projects vertically therefrom and can thus engage through the groove 30 in a simple manner when the inner part 4a is arranged within the outer part 4b.

Here, the groove 30 can have a widening 31 at one end in order to allow the hook 29 to be guided through in a simple manner (FIG. 15). However, there can also be provision to form the groove with a uniform width (FIG. 14) in which the inner part 4a with the hook 29, after being inserted into the groove 30, has to be rotated through 90° in order to pass into the desired position. A reliable captive securement is thereby obtained.

The inner part 4a is arranged so as to be rotatable within the inner part 4b at least to a certain degree. This ensures that, upon tensioning of the tensioning device (not shown), which are guided through corresponding leadthroughs 32 in the inner part 4a, no bending moments act on the tensioning device. Here, there can optionally be provision for the leadthroughs 32 of an inner part of one of the tensioning heads 4, 5 to have a thread incorporated therein that allows direct screwing in of a tensioning device in the form of a tensioning screw, thus making it possible to dispense with a threaded nut.

FIG. 17 schematically shows an embodiment of the profiled clamp in which the tensioning device 6 applies a force to the tensioning heads 4, 5 such that they are urged toward one another in order to tension the clamp band 2 of the profiled clamp 1. The tensioning device 6 here takes the form of a brace which engages in cutouts of the tensioning heads 4,5 and can thus hold the profiled clamp in the tensioned state.

FIG. 18 shows an alternative embodiment in which, to tension the profiled clamp, the tensioning device applies a force to the tensioning heads 4, 5 such that they are urged away from one another. For this purpose, ends of the clamp band 2 intersect in a region between the tensioning heads 4, 5. Here, in the simplest case, the tensioning device 6 can be designed as a means which is clamped between the tensioning heads 4,5 in a simple manner.

The disclosure allows a new design concept for a profiled clamp that allows universal use of the profiled clamp and the production for example of different diameters with the same tools. Here, it is not restricted to one of the above-described embodiments but can be modified in a wide variety of ways. In particular, the shape of the profile of the profiled element is not restricted to the shape shown, but can be correspondingly adapted to suit the respective requirements. Furthermore, additional elements, such as for example prepositioners or sensors and the like, can be combined with the profiled clamp according to the disclosure in a simple manner.

The novel profiled clamp is distinguished by its flexible module frame in combination with a profiled element which together can be produced in a continuous process and which effectively convert the forces of the tensioning device into circumferential forces. Here, the flexible module frame allows uniform introduction of force and, through the choice of the embodiment, for example as a wire cable, wire rope or the like, a variable adaptation to the respective requirements.

The configuration of the profiled element likewise allows a flexible production in which, for example through the choice of the number of profiled segments, the length of the profiled element is determined and can thus be selected in accordance with the desired diameter of the profiled clamp. Here, the profiled element can be produced together with the module frame or else be produced separately therefrom and then connected thereto. All known connecting methods come into consideration here, for example clipping, welding or crimping. The tensioning heads according to the disclosure here allow a flexible and robust connection between the tensioning device and the module frame.

All of the features and advantages emerging from the claims, the description and the drawing, including constructional details, spatial arrangements and method steps, may be essential to the invention both on their own and in the various combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

1 Profiled clamp
2 Clamp band
3 Module frame
4 Tensioning head
5 Tensioning head
6 Tensioning device
7 Profiled element
8 Profiled segments
9 Strand
10 Strand
11 Flange
12 Pipe connection
13 Stop element
13 Axial recess
15 Axial recess
16 Groove
17 Groove
18 Flank
19 Flank
20 Base
21 Corrugation crests
22 Corrugation troughs
23 Receptacles
24 Tensioning bolt
25 End
26 Element
27 Slot
28 Guide

1. A profiled clamp having a clamp band, which has a tensioning head at each of its ends, the tensioning heads being connected to one another via a tensioning device, wherein the clamp band has a profiled element and a module frame which extends in a circumferential direction, to which the profiled element is connected and on which it is supported at least in a radial direction, wherein the tensioning heads are arranged on ends of the module frame.

2. The profiled clamp as claimed in claim 1, wherein the profiled element has a plurality of profiled segments which are arranged next to one another in the circumferential direction and which are connected to one another at least by the module frame.

3. The profiled clamp as claimed in claim 2, wherein the profiled segments are connected to one another in an integrally bonded manner, wherein the profiled segments are formed in one piece with one another.

4. The profiled clamp as claimed in claim 2, wherein the profiled segments are individually fastened to the module frame.

5. The profiled clamp as claimed in claim 1, wherein the module frame at least partially covers a radial outer side of the profiled element.

6. The profiled clamp as claimed in claim 5, wherein the module frame is formed from a strip-shaped element.

7. The profiled clamp as claimed in claim 5, wherein the profiled element has a corrugated structure with corrugation crests and corrugation troughs running in an axial direction, wherein a receptacle suitable for receiving flanges of a pipe connection is formed in the corrugation crests, wherein the receptacles of the corrugation crests are arranged in the same axial position.

8. The profiled clamp as claimed in claim 1, wherein the module frame has two strands which run substantially in a circumferential direction and which are arranged parallel to one another and spaced apart from one another in the axial direction, wherein the profiled element connects the two strands in the axial direction.

9. The profiled clamp as claimed in claim 8, wherein the strands are formed from a wire rope in each case.

10. The profiled clamp as claimed in claim 8, wherein the strands are formed from a solid wire cable in each case.

11. The profiled clamp as claimed in claim 8, wherein the profiled element is curved radially outward between its axial edges.

12. The profiled clamp as claimed in claim 8, wherein the profiled element has at each of its axial edges a radially outwardly open groove through which one of the strands is respectively guided.

13. The profiled clamp as claimed in claim 8, wherein the profiled element has at each of its axial edges a material doubling which is produced by folding and around which a strand engages in each case.

14. The profiled clamp as claimed in claim 1, wherein the tensioning heads each have a tensioning bolt around which the module frame is at least partially guided in each case.

15. The profiled clamp as claimed in claim 14, wherein ends of the module frame are at least partially guided through the tensioning bolt.

16. The profiled clamp as claimed in claim 1, wherein, to tension the profiled clamp, the tensioning device applies a force to the tensioning heads such that they are urged toward one another.

17. The profiled clamp as claimed in claim 1, wherein, to tension the profiled clamp, the tensioning device applies a force to the tensioning heads such that they are urged away from one another.
